(19) United States
(12) Patent Application Publication
(10) Pub. No.: US 2007/0175923 A1
(43) Pub. Date: Aug. 2, 2007

(54) Defense spray with wind indicator

(76) Inventor: Michael McEvoy, Pensacola, FL (US)

Correspondence Address: HERRON LAW OFFICE, PO BOX 2678, KANSAS CITY, KS, 66110, US

(21) Appl. No.: 11/341,362

(22) Filed: Jan. 30, 2006

(51) Int. Cl. B67D 1/07; B67D 5/06; G01P 13/00; G09F 17/00; B67D 5/08

(52) U.S. Cl. 222/192; 222/23; 73/170.05; 73/170.01; 116/173; 239/71

(57) ABSTRACT

The invention is a defense spray with a wind indicator. The defense spray comprises a pressurized irritant contained within a canister having a ribbon dangling therefrom. The ribbon is configured and constructed to visibly react to moving ambient air.

### SUMMARY OF THE INVENTION

The invention is a defense spray with a wind indicator. Defense sprays, such as pepper sprays, tear gas, and mace are commonly known in the art. For example, U.S. Pat. No. 3,228,565 to Stanzel (which is incorporated herein by reference) U.S. Pat. No. 1,885,126 (which is incorporated herein by reference) each disclose pertinent defense sprays.

Because these devices expel airborne irritants, wind can often cause one to miss the intended target. Even worse, wind can misdirect the irritant so that an unintended target—or even the operator—is affected by the spray.

The invention includes a container filled with pressurized or aerosolized defense spray, such as orthochlorobenzalmalononitrile, chloroacetophenone, dibenz(b,f)-1,4-oxazepin, or oleoresin capsicum. Airborne versions of these compositions will irritate (and preferably temporarily disable) an assailant, allowing a targeted person time to escape the assailant. Also, the irritation created by these formulae is usually temporary and commonly erodes in less than an hour, depending on the sensitivity of the assailant's mucous membranes.

The current invention includes an attachment to a common defense spray. Generally, the invention includes a canister of pressurized irritant, which is usually in a container that is approximately palm-sized. The invention will also include a weighted ribbon or tether attached to the container. As one removes the container from its holster (or pocket, or purse), the weighted ribbon will dangle downwardly. As the operator points the spray in the direction of the intended target, the operator will be able to discern wind direction by observing the movement of the ribbon.

Several embodiments of the invention are shown. The ribbon may be attached to the container by any known method, such as common adhesive, a hook position on a bottom face of the container, a snap-like connector, or a hook-and-loop fastener type connection. The ribbon, cord, or tether may also be looped around the container.

Any known weight may be used, such as a lightweight key, washer, common pendant or tag. In a preferred embodiment, the ribbon bears a snap or button adjacent its terminal end. In this embodiment, the button or snap will not only act to provide weight to the terminal end of the ribbon, the snap may also be used to position or anchor the canister to a selected location (such as the interior portion of a purse or handbag) in order to make the canister easy to locate and access in an emergency or distress.

Alternatively, the material may be weighted at its bottom. Although not required, it is preferred that a light weight of some kind be used, but it is important that the weighted end be light enough so a breeze will create a discernable movement of the ribbon. Indeed, if the terminal end of the ribbon is too heavy, it will not be an effective wind indicator as only stronger gusts will cause a discernable change in position.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective view of the inventive defense spray with wind indicator, according to the principles of the invention.

FIGS. 2-6 show perspective views of alternate embodiments of the defense spray with wind indicator.

FIG. 7 shows four comparative plan views that isolate the bottom of the canister of the defense spray with wind indicator, according to the principles of the invention.

### DETAILED DESCRIPTION OF THE PREFERRED EMBODIMENTS

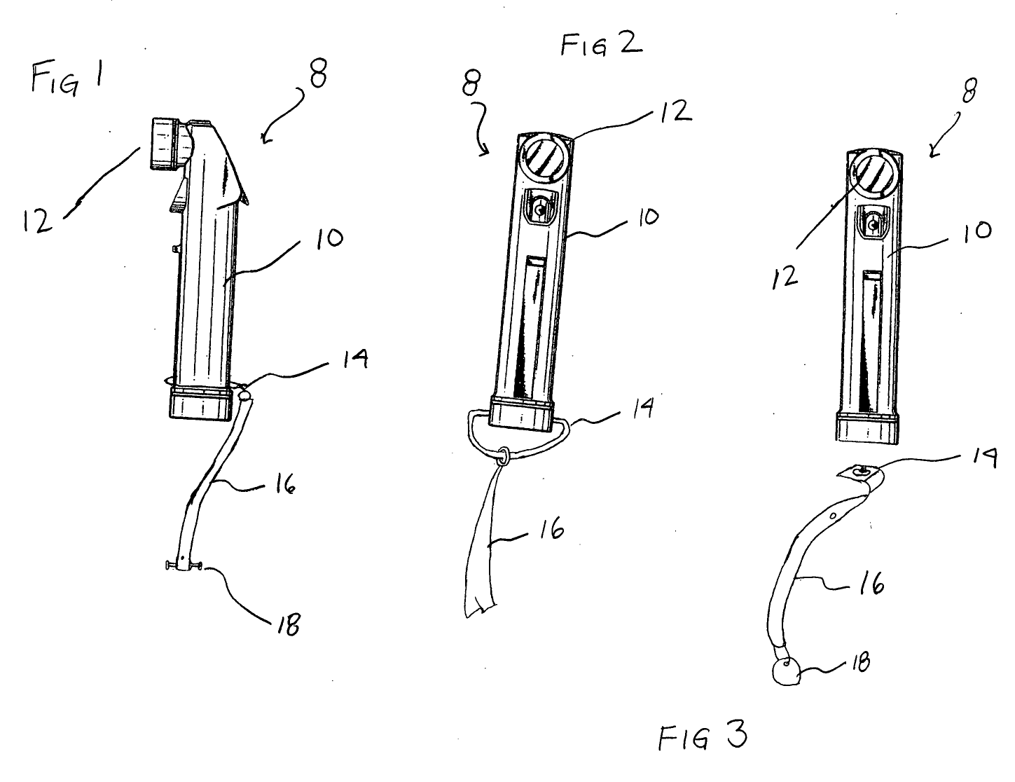

FIG. 1 shows a first embodiment of the inventive device 8, which is a defense spray with wind indicator, according to the principles of the invention. The device 8 includes a canister 10 that contains pressurized irritant therein. The irritant may include mace, tear gas, or pepper spray such as orthochlorobenzalmalononitrile, chloroacetophenone, dibenz(b,f)-1,4-oxazepin, or oleoresin capsicum.

Still referring to FIG. 1, the device 8 will have an outlet 12 positioned at a first end of the canister 12, and a connector 14 attaching a ribbon 16 adjacent the second end of the canister 10. The ribbon 16 is attached to the canister 14 at its first end, and its free end is free to dangle downwardly from the canister 10. In the embodiment shown, a light weight 18 is positioned near the terminus of the ribbon 16.

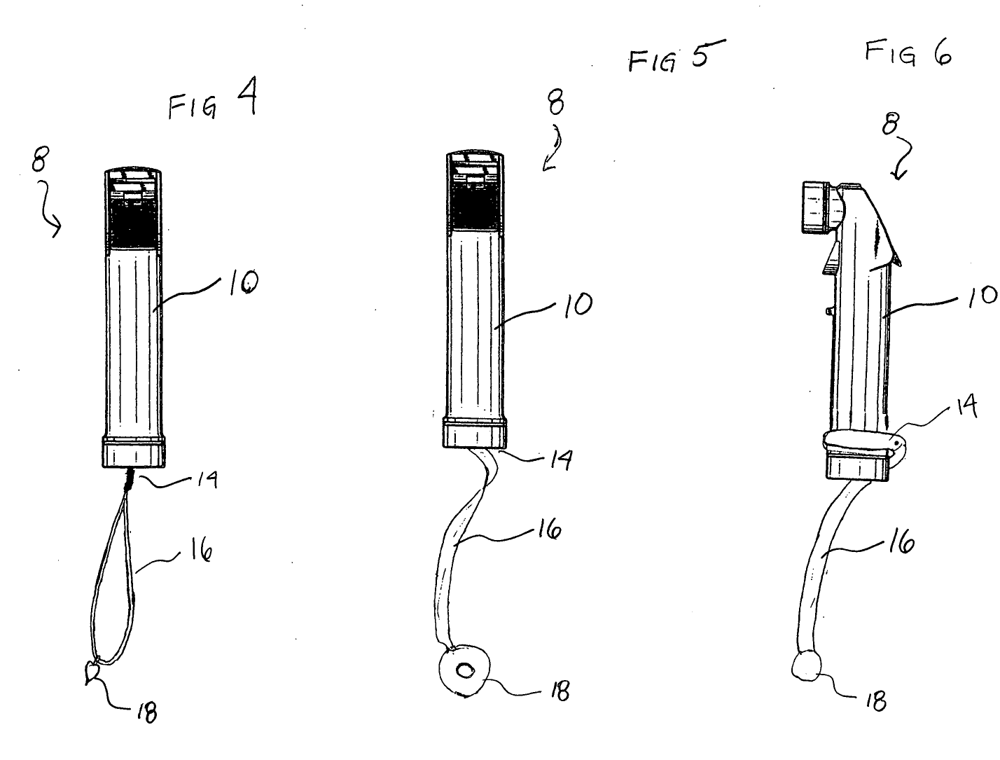

FIG. 2 shows a second preferred embodiment of the device 8. As shown, the connector 14 may include a fastener 14 that is rotatably connected to the canister 10 adjacent its second end; of course, the spray outlet 12 is positioned adjacent the first end of the canister 10. This connector 14 forms a closed loop from which the ribbon 16 is allowed to dangle freely.

As shown in FIG. 2, the ribbon 16 may comprise a cloth that broadens distal the canister 10 (and connector 14), thereby giving increased weight to the terminus of the ribbon 16, which in turn encourages the ribbon 16 to dangle downwardly, yet freely. The free end of the ribbon 16 is free to engage the wind and provide visual clues as to the direction of any movement of the ambient air.

FIG. 3 shows another preferred embodiment of the device 8, according to the principles of the invention. The device 8 depicted in FIG. 3 includes a canister 10 having an outlet 12 configured to expel irritant therefrom. A connector 14 is positioned distal the outlet, and connects the ribbon 16 to the canister 10.

As shown in FIG. 3, the connector 14 may comprise a snap 14 (or known connector) that can mate with a connector (not viewable in FIG. 3, but described aft) positioned on a bottom surface of the canister.

FIG. 4 shows yet another embodiment of the device 8. A connector 14 positioned adjacent the bottom of the canister connects a ribbon or tether 16 to a pendant 18. As with other embodiments, it is important that the ribbon or tether 16 and pendant 18 be selected to be light enough to catch a breeze and provide visual clues as to the direction and/or movement of ambient air. Indeed, in any embodiment, if the pendant 18 is too heavy to allow a relatively free response to ambient air movement, then the wind indicator will be ineffective.

In FIG. 5, the connector 14 comprises a hook-and-loop fastener positioned adjacent the bottom of the canister 10. The ribbon 16 connects a washer 18 to the canister, and provides weight to the terminus of the ribbon 16.

FIG. 6 shows an alternate method of conneting the ribbon 16 to the canister 10. In this embodiment, the connector 14 comprises a loop at the first end of the ribbon 16; this loop envelopes the canister 12 near its bottom. The terminus of the ribbon 16 is weighted by a tag, such as an id tag, or a tag bearing indicia of the content of the irritant within the canister 10.

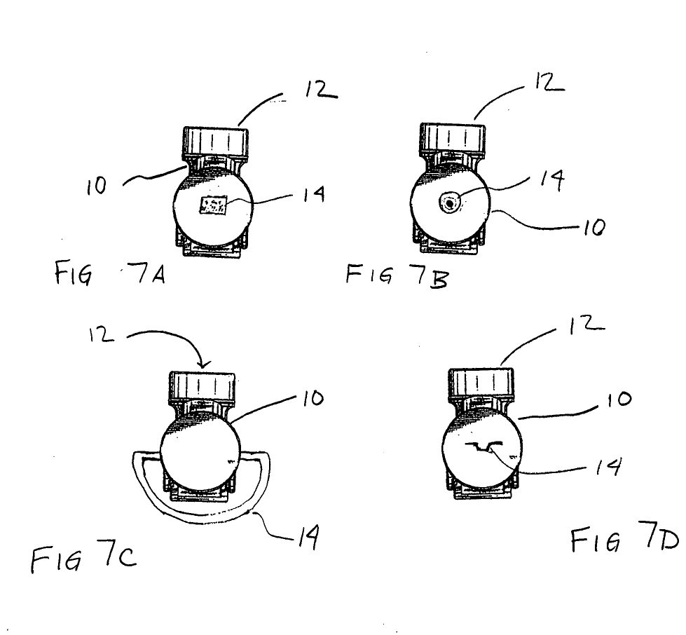

FIGS. 7A-7D show various alternate embodiments for connectors 14 that are positioned adjacent the bottom end of the canister. Specifically, FIG. 7A shows a hook-and-loop connector 14 positioned on the bottom of the canister 10. FIG. 7B, however, shows a snap-type connector 14 positioned an the bottom surface of the canister.

FIG. 7C, however, shows a fastener 14 that is rotatably connected to the canister 10 adjacent its second end. To clarify, FIG. 7C isolates the fastener 14 that is more completely shown in FIG. 2. Moreover, FIG. 7D shows a connector 14 that could be engaged by a hook or loop affixed to a ribbon or tether, such as the embodiment more completely shown in FIG. 4.

Although the present invention has been described and illustrated in detail, these descriptions and drawings are for illustration and example only, and are not to be taken by way of limitation. The spirit and scope of the present invention are to be limited only by the appended claims.

I claim:

1. A defense spray with a wind indicator, comprising:
a canister containing pressurized irritant,
a ribbon having a first end connected to the canister and a second end free to dangle from the canister; wherein,
the ribbon is configured and constructed to visibly react to moving ambient air.

2. The defense spray with wind indicator as in claim 1, wherein the irritant includes at least one of
a orthochlorobenzalmalononitrile;
b. chloroacetophenone;
c. dibenz(b,f)-1,4-oxazepin; or,
d. oleoresin capsicum.

3. The defense spray wind indicator as in claim 1, wherein the irritant is pressurized by aerosol.

4. The defense spray with wind indicator as in claim 1,
the canister having a first end and a second end displaced from one another along a longitudinal axis; and,
the irritant is expelled from the canister by depressing a button positioned adjacent the first end; and,
the irritant is expelled from an outlet adjacent the button; and,
the ribbon is affixed adjacent the second end of the canister.

5. The defense spray with wind indicator as in claim 1, further including:
a loop formed adjacent the first end of the ribbon; wherein,
the ribbon is affixed to the canister by engaging the canister within the loop.

6. The defense spray with wind indicator as in claim 4, the ribbon affixed to the canister by one of
a snap-type connection;
a hook and loop fastener connection; or
an adhesive positioned between the canister and the ribbon.

7. The defense spray with wind indicator as in claim 1, further including
a connector positioned adjacent the second end of the ribbon; the connector configured to retain one of:
a washer;
a tag; or,
a pendant.

8. The defense spray with wind indicator as in claim 1, further including a connector positioned adjacent the second end of the ribbon, the connector configured to removably attach to a selected item.

9. The defense spray with wind indicator as in claim 8, further comprising a holster for the canister.

10. The defense spray with wind indicator as in claim 8, the selected surface being one of a purse, a jacket pocket, or an article of clothing.

11. The defense spray indicator as in claim 9, wherein the selected item is a holster for the canister.
